(19) United States
(12) Patent Application Publication
(10) Pub. No.: US 2026/0351238 A1
(43) Pub. Date: Nov. 5, 2026

(54) GENERATION APPARATUS, LEARNING APPARATUS, GENERATION METHOD, LEARNING METHOD, AND PROGRAM

(71) Applicant: NIPPON TELEGRAPH AND TELEPHONE CORPORATION, Tokyo (JP)

(72) Inventors: Ko MITSUDA, Tokyo (JP); Ryuichiro HIGASHINAKA, Tokyo (JP); Kuniko SAITO, Tokyo (JP)

(73) Assignee: NIPPON TELEGRAPH AND TELEPHONE CORPORATION, Tokyo (JP)

(21) Appl. No.: 19/115,515

(22) PCT Filed: Sep. 30, 2022
(86) PCT No.: PCT/JP2022/036841

§ 371 Date: Mar. 26, 2025

(51) Int. Cl. G10L 13/027; G10L 15/02

(52) U.S. Cl. CPC G10L 13/027; G10L 15/02

(57) ABSTRACT

A generation device including: an extraction unit that extracts one or more pieces of content information indicating content of specific information from the specific information; and a transformation unit that generates an utterance adjusted to the content of the specific information and matching a dialogue context from the dialogue context and the one or more pieces of content information by using a transformation model.

### TECHNICAL FIELD

The present invention relates to a technique in which a computer generates an utterance in a dialogue.

### BACKGROUND ART

In a dialogue system, a human has a dialogue with a computer to obtain various types of information or fulfill requests. In addition, there is also a dialogue system for having daily conversations instead of achieving a predetermined task, and the system allows a human to obtain mental stability, satisfy the desire for approval, or build a trust relationship.

On the other hand, research for achieving discussions with a computer are also in progress, in addition to task achievement and daily conversation. The discussion has a function of changing human value judgment and organizing thoughts, and plays an important role for humans.

For example, Non Patent Literature 1 discloses a technique in which a user utterance is mapped to a node using graph data having an opinion as a node, and a node having a connection relationship with the mapped node is returned to the user as a system utterance, whereby a discussion is achieved. The graph data is manually created on the basis of, for example, a preset agenda of discussion (such as “For permanent residence, an urban area is better than a rural area”). It is possible to have a discussion on a specific topic by using data of a manually created discussion.

### CITATION LIST

### Non Patent Literature

Non Patent Literature 1: Ryuichiro Higashinaka et al., Argumentative dialogue system based on argumentation Structures, Proceedings of The 21st Workshop on the Semanticsand Pragmatics of Dialogue, p154-155, 2017

### SUMMARY OF INVENTION

### Technical Problem

In the technique disclosed in Non Patent Literature 1, an utterance to be output is selected from among response candidates prepared in advance. Therefore, the output is not necessarily a fluent response that matches the context of the dialogue. That is, in the conventional technique, an appropriate utterance that matches the context of the dialogue cannot be output.

The present invention has been made in view of the above circumstances, and an object is to provide a technique for outputting an appropriate utterance that matches the context of a dialogue.

### Solution to Problem

According to the disclosed technique, there is provided a generation device including: an extraction unit that extracts one or more pieces of content information indicating content of specific information from the specific information; and a transformation unit that generates an utterance adjusted to the content of the specific information and matching a dialogue context from the dialogue context and the one or more pieces of content information by using a transformation model.

### Advantageous Effects of Invention

According to the disclosed technique, there is provided a technique for outputting an appropriate utterance that matches the context of a dialogue.

### BRIEF DESCRIPTION OF DRAWINGS

FIG. 1 is a configuration diagram of a generation device 100.

FIG. 2 is a flowchart for describing an operation of the generation device 100.

FIG. 3 is a diagram illustrating an example of a dialogue context.

FIG. 4 is a diagram illustrating an example of a scenario,

FIG. 5 is a diagram illustrating an example of a scenario serving as an input to the generation device 100.

FIG. 6 is a diagram illustrating an example of a program corresponding to an extraction unit 110.

FIG. 7 is a diagram illustrating an example of a content word list.

FIG. 8 is a diagram illustrating an example of input to a transformation model.

FIG. 9 is a diagram illustrating an example of output from a transformation model.

FIG. 10 is a configuration diagram of a training device 200.

FIG. 11 is a flowchart for describing an operation of the training device 200.

FIG. 12 is a diagram illustrating an example of dialogue data used for creating transformation training dialogue data.

FIG. 13 is a diagram illustrating an example of transformation training dialogue data.

FIG. 14 is a diagram illustrating an example of transformation training dialogue data.

FIG. 15 is a diagram illustrating a hardware configuration example of a device.

### DESCRIPTION OF EMBODIMENTS

Hereinafter, an embodiment of the present invention (the present embodiment) will be described below with reference to the drawings. The embodiment to be described below is merely exemplary and embodiments to which the present invention is applied are not limited to the embodiment to be described below.

In the present embodiment, an operation of generating an utterance or the like for the Japanese language has been described, but using the Japanese language is an example. The technique according to the present invention is also applicable to languages other than the Japanese language.

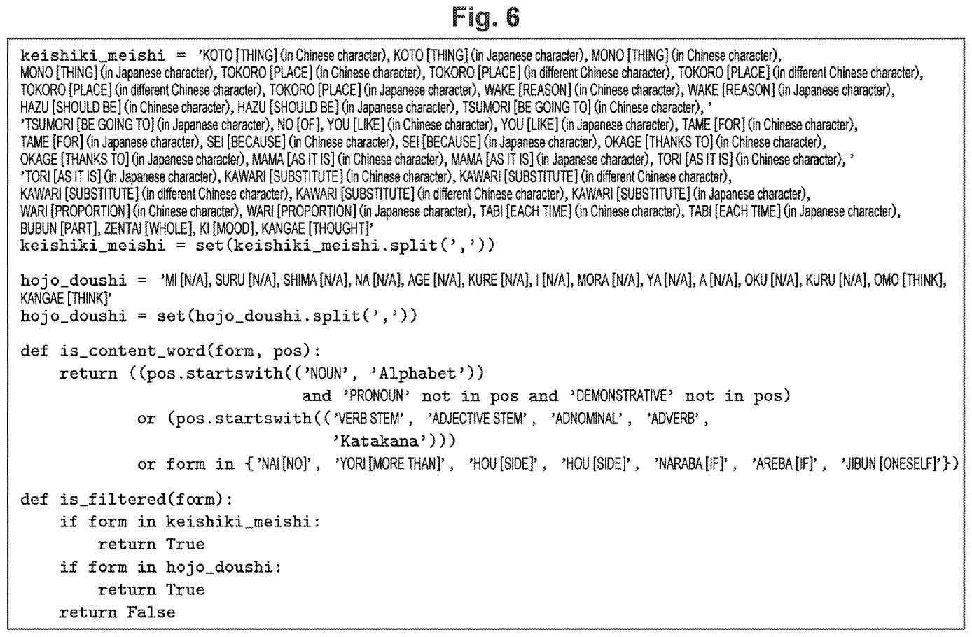

In addition, in a case where the present specification and the drawings filed in the Japanese language are translated into other languages, the generation device 100 and the training device 200 according to the present embodiment can perform the operations described in the translated present specification and drawings by adjusting to the other languages as necessary. As the above adjustment, for example, the extraction unit 110 (program is illustrated in FIG. 6) to be described below is adjusted so that a content word of another language can be extracted.

### Outline of Embodiment

As described above, in the technique disclosed in Non Patent Literature 1, since an utterance output by the system is selected from among response candidates prepared in advance, an appropriate (fluent) utterance that matches the context of the dialogue cannot be output.

Here, in order to output an appropriate (fluent) utterance that matches the context of the dialogue, it is conceivable to prepare a large amount of utterances (triad of response candidate, context, and rewritten response) in which each response candidate is rewritten according to the context, and to use an utterance generation model that generates a rewritten response candidate using the response candidate and the context as inputs. However, since the context is diverse, collecting such triad data for each topic of discussion is costly. Therefore, this method is not practical. Note that this method is not a known technique.

In order to solve the above problem, in the present embodiment, by using a natural sentence related to a specific topic as a scenario of dialogue and inputting the scenario and an arbitrary dialogue context to the generation device 100, the generation device 100 outputs an utterance that is consistent with the scenario and has sufficient fluency for the dialogue context.

More specifically, first, dialogue data regarding a desired topic is collected. The pre-trained transformation model (a model that outputs an appropriate utterance that matches the dialogue context using the dialogue context as an input) is retrained using the dialogue data. At this time, as a device of the training method, the content of the utterance included in the output is extracted in advance, and the transformation model is trained so as to restore the original utterance using the dialogue context and the content as inputs to the transformation model.

By inputting the dialogue context and the content to be uttered to the trained transformation model, it is possible to output an utterance that is consistent with the content to be uttered and has sufficient fluency for the dialogue context.

Hereinafter, a device configuration and a device operation according to the present embodiment will be described in detail. Hereinafter, the device configuration and the device operation for each of an inference phase and a training phase will be described separately. Note that, in the following, an example in a case where the generation device 100 in the inference phase and the training device 200 in the training phase are separate devices is indicated, but the generation device 100 and the training device 200 may be configured as one device. For example, the generation device 100 may include a training unit 160, or the training device 200 may perform inference (utterance generation) after training.

### Inference Phase: Configuration and Operation of Generation Device 100

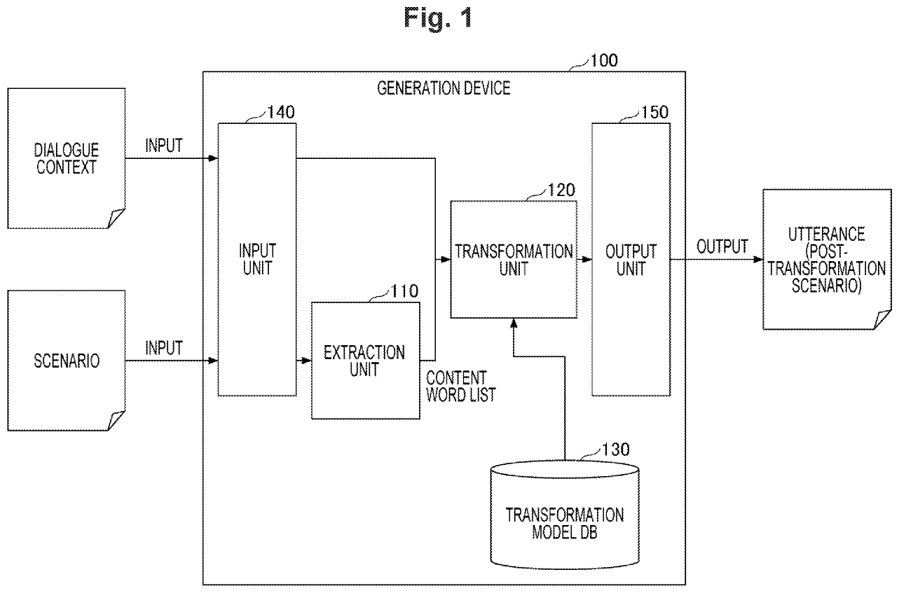

FIG. 1 is a configuration diagram of the generation device 100 that generates an utterance in the inference phase. As illustrated in FIG. 1, the generation device 100 includes the extraction unit 110, a transformation unit 120, a transformation model database (DB) 130, an input unit 140, and an output unit 150. Note that the transformation model database (DB) 130 may be a DB external to the generation device 100.

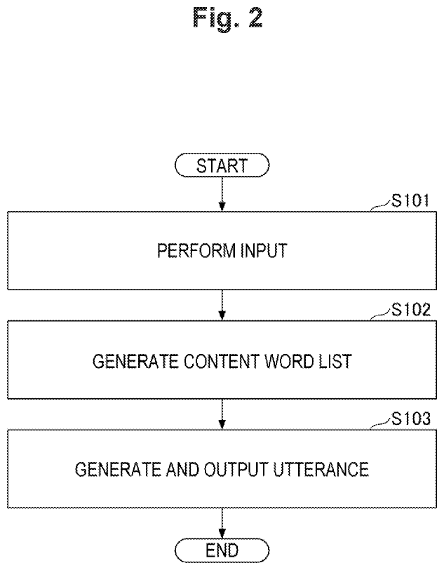

The generation device 100 can generate a dialogue (a discussion in the present example) by self-dialogue. Note that the self-dialogue here means that one system is divided into speaker A and speaker B and gives an utterance alternately to generate a dialogue. The outline of the operation of the generation device 100 will be described with reference to the flowchart of FIG. 2.

In S101, a certain dialogue context and scenario are input by the input unit 140. The scenario is a sentence having a content corresponding to the next utterance of the last sentence (utterance) in the dialogue context.

In S102, the scenario is input to the extraction unit 110, and the extraction unit 110 extracts a content word from the scenario and outputs a content word list that is a list of content words. The content word corresponds to a word indicating the content of the utterance to be output by the generation device 100.

The trained transformation model is stored in the transformation model DB 130, and the transformation unit 120 reads and holds the transformation model from the transformation model DB 130. In the present embodiment, it is assumed that the transformation model is a model of a neural network, and trained parameters in the neural network are stored in the transformation model DB 130 as the transformation model. A training method of the transformation model will be described below. Note that the transformation unit 120 may be regarded as a transformation model.

In S103, the transformation unit 120 inputs, to the transformation model, the dialogue context and the content word list extracted from the scenario, and obtains an utterance (which may be referred to as an utterance sentence) to be output from the transformation model. The transformation unit 120 passes the utterance to the output unit 150, and the output unit 150 outputs the utterance. The output from the output unit 150 may be performed by a voice heard by the ear or a text viewed by the eye.

The output utterance is an utterance that matches the dialogue context. In addition, since the output utterance corresponds to one obtained by transforming the input scenario to match the dialogue context, this may be referred to as a “post-transformation scenario”. Note that the “utterance that matches the dialogue context” may be rephrased as an “utterance adjusted to the dialogue context”, an “utterance following fluently from the last sentence of the dialogue context”, or the like.

Thereafter, the dialogue context obtained by adding the utterance output from the generation device 100 to the dialogue context used for input and the next scenario (utterance) of the scenario (utterance in the scenario) used for input are input to the generation device 100, whereby a fluent next utterance that matches the input dialogue context can be generated. By E repeating this processing, it is possible to generate a dialogue (sequence of utterances).

Hereinafter, each component (dialogue context, scenario, extraction unit 110, transformation unit 120 (transformation model), utterance (post-transformation scenario) ) appearing in the above-described processing in the inference phase will be described in detail.

### <Dialogue Context>

The dialogue context is a text to be an input to the transformation unit 120 (transformation model). The transformation model generates an utterance following the input dialogue context. When there is no dialogue context (that is, when an empty character is input), the transformation model generates a leading utterance of the dialogue. Note that, as will be described below, the content word list is input to the transformation model together with the dialogue context, but in the description of the dialogue context here, only the dialogue context is used as an input to the transformation model for the sake of convenience of description.

In a case where the dialogue (dialogue context) is generated by the transformation model, first, an empty character is input to the transformation model to generate a leading utterance (first utterance). Next, the leading utterance is input as the dialogue context, and a second utterance is generated. Next, the first utterance and the second utterance are input as the dialogue context, and a third utterance is generated. By repeating this input and output, it is possible to generate a dialogue including an arbitrary number of utterances. The dialogue generated by the transformation model can be used as a dialogue context input to the transformation model.

The dialogue context input to the transformation model is not limited to the dialogue generated by the transformation model. Any sequence of utterances can be used as the dialogue context input to the transformation model. In addition, a dialogue in which an arbitrary utterance is included in the dialogue generated by the transformation model can also be used as the dialogue context input to the transformation model.

In addition, for example, the dialogue context input to the transformation model may include a template utterance prepared manually (for example, an utterance indicating a response “uh-huh”), or may include an utterance generated by a dialogue system different from the generation device 100 according to the present embodiment.

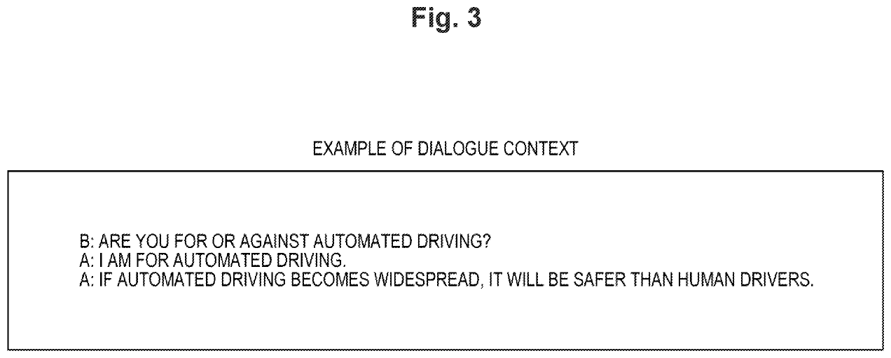

FIG. 3 illustrates an example of a dialogue context. This example illustrates a dialogue between speaker A (supporter) and speaker B (opponent) who discuss about the pros and cons of automated driving, and is an input to the transformation model for generating an utterance following the third utterance. Each utterance in the dialogue context illustrated in FIG. 3 is generated by the generation device 100.

### <Scenario>

The scenario is a text that is a source of an utterance to be generated by the generation device 100, and includes one or a plurality of sentences (specifically, natural sentences). The scenario may be manually created, or may be automatically created from a knowledge base used as a discussion structure using the technique disclosed in Non Patent Literature 1. In the following description, a scenario created by the method disclosed in Non Patent Literature 1 (a method of tracing a discussion structure from the root node and using visited nodes as a scenario) will be described as an example.

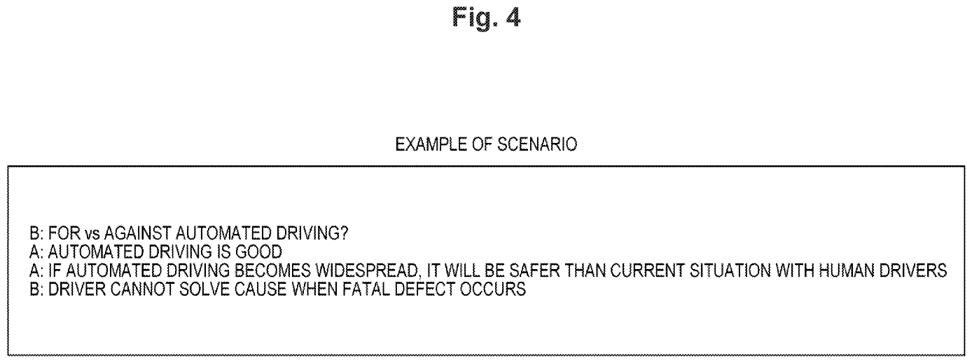

FIG. 4 illustrates an example of a scenario. This example is a scenario corresponding to the dialogue context of FIG. 3, and the dialogue of FIG. 3 is generated using the first to third utterances of the present scenario. By inputting the generated dialogue context of FIG. 3 and the utterance of the subsequent scenario (a fourth utterance of the scenario) to the generation device 100, an utterance following the dialogue context is generated. The generated utterance is an utterance adjusted to the content of the scenario and having fluency for the dialogue context.

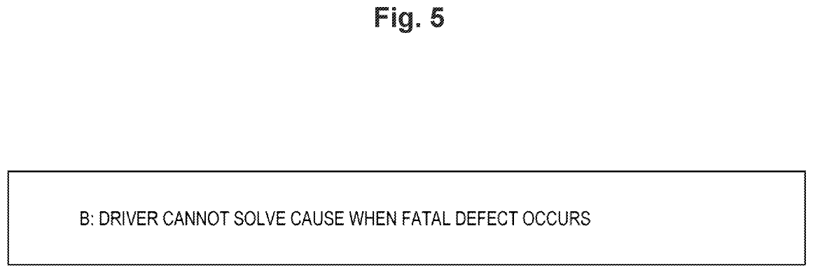

FIG. 5 illustrates an example of a scenario actually used as an input to the generation device 100. As an input to the generation device 100, only the last utterance in the scenario (FIG. 4) including a plurality of utterances is used. Note that only the last utterance may also be referred to as a “scenario”.

The example illustrated in FIG. 5 corresponds to the dialogue context illustrated in FIG. 3, and is an input to the generation device 100 for generating an utterance representing the content of FIG. 5, which fluently follows the dialogue context of FIG. 3.

### <Extraction Unit 110>

The extraction unit 110 receives the scenario (the last utterance described above), extracts a content word corresponding to the content included in the scenario from the scenario, and outputs a content word list including the extracted content word.

First, the extraction unit 110 performs morphological analysis on the input scenario to obtain morphemes and their part-of-speech information. The extraction unit 110 includes a morphological analyzer, and the morphological analyzer executes morphological analysis. Any morphological analysis can be used, and for example, MeCab or richindexer can be used.

As described below, the generation device 100 can be implemented by, for example, a computer and a program. FIG. 6 illustrates an example of a program when the extraction unit 110 is implemented by the program operating on the computer. Here, a Python program is illustrated as an example.

The program illustrated in FIG. 6 defines a function of is content word that receives a morpheme character string (form) and a part of speech (pos) output from the morphological analyzer (for example, richindexer) and returns whether the morpheme character string and the part of speech correspond to the content word, and a function of is filtered that determines a morpheme character string to be exceptionally excluded.

Using this program, the above two functions are applied to the morpheme string and the part-of-speech string output by the morphological analyzer (for example, richindexer), and the morpheme determined as the content word is output as the content word list. The extraction unit 110 exceptionally includes morphemes (for example, “nai [no]” representing negation of proposition, “hou [side]” representing a comparison between two positions, “naraba [if]” dealing with a hypothetical proposition, or the like) considered to be important in the discussion in the content word list by this program.

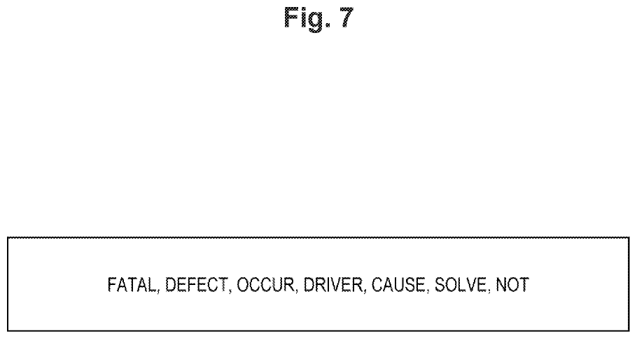

FIG. 7 illustrates a content word list extracted from the scenario of FIG. 5 by the extraction unit 110. By comparing the scenario of FIG. 5 with FIG. 7, it can be seen that keywords corresponding to the content of the scenario are listed in the content word list. The information of the content word list is used as reference information when the transformation model to be described below generates an utterance.

### <Transformation Unit 120 (Transformation Model)>

Next, the transformation model used in the transformation unit 120 will be described. The transformation model is a model obtained by training (which may be referred to as fine-tuning) a dialogue model pre-trained by general dialogue data with transformation training dialogue data to be described below.

As the pre-trained dialogue model, a model available online (for example, a Transformer Encoder-decoder dialogue model published by the applicant) may be used. In this case, pre-training is unnecessary, and the transformation model can be generated by performing fine-tuning using the transformation training dialogue data. Here, it is assumed that the transformation unit 120 holds a trained transformation model.

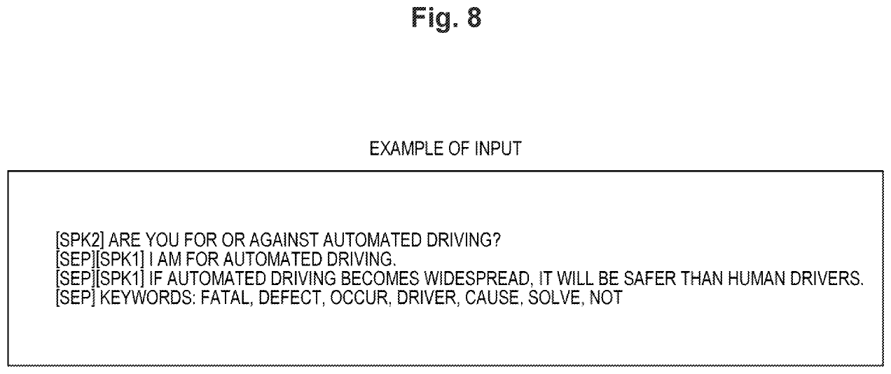

FIG. 8 illustrates an example of an input to the transformation model at the time of utterance generation. In this example, a content word list extracted by using the extraction unit 110 from the scenario “the driver cannot solve the cause when a fatal defect occurs” is added to the dialogue context of FIG. 3. In the example illustrated in FIG. 8, the input spans a plurality of lines, but in practice, there is no line feed and the input is performed as a text of one line. SPK1 represents speaker A, SPK2 represents speaker B, and SEPs represent input delimiters (for example, those arranged between utterances).

The transformation model generates a fluent utterance that matches the dialogue context according to the content of the scenario on the basis of the input (information indicating the dialogue context and the content of the scenario).

### <Utterance (Post-Transformation Scenario)>

The transformation unit 120 outputs the utterance generated by the transformation model (post-transformation scenario) via the output unit 150. Here, the utterance (post-transformation scenario) is referred to as an output utterance. By creating the output utterances in order from before the dialogue (first utterance) according to the scenario, it is possible to create a fluent dialogue along the scenario.

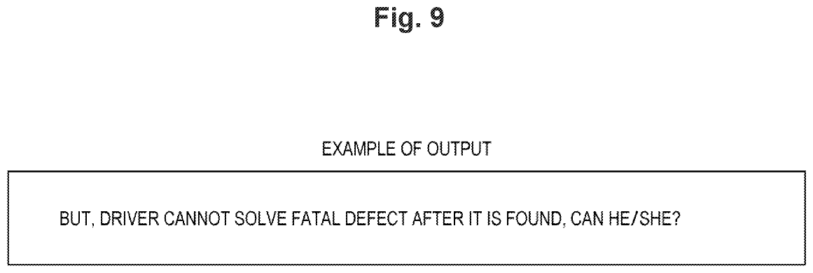

FIG. 9 illustrates an example of an output utterance generated from the input of FIG. 8. This example corresponds to an utterance obtained by transforming the scenario “the driver cannot solve the cause when a fatal defect occurs” illustrated in FIG. 5.

The example illustrated in FIG. 9 is output as an utterance following the dialogue context illustrated in FIG. 3, and it can be seen that as compared with the original scenario “the driver cannot solve the cause when a fatal defect occurs”, the expression is corrected to include “demo [but]” or “dekimasanyone? [can he/she?]”, so that the utterance is more fluent. The transformation model reads a keyword included in the input, and adds an appropriate expression between words while leaving words necessary for a fluent utterance following the content, so that a desired utterance as in the example can be generated.

Note that, in the above example, the scenario is a sentence, but the scenario is not limited to the sentence. For example, the scenario may be a video. In this case, for example, a specific image in the video (or a specific video) is input to the extraction unit 110, the extraction unit 110 outputs content information (example: a content word) indicating the content of the specific image (or the specific video), and the content information is input to the transformation unit 120 together with the dialogue context.

### Training Phase: Configuration and Operation of Training Device 200

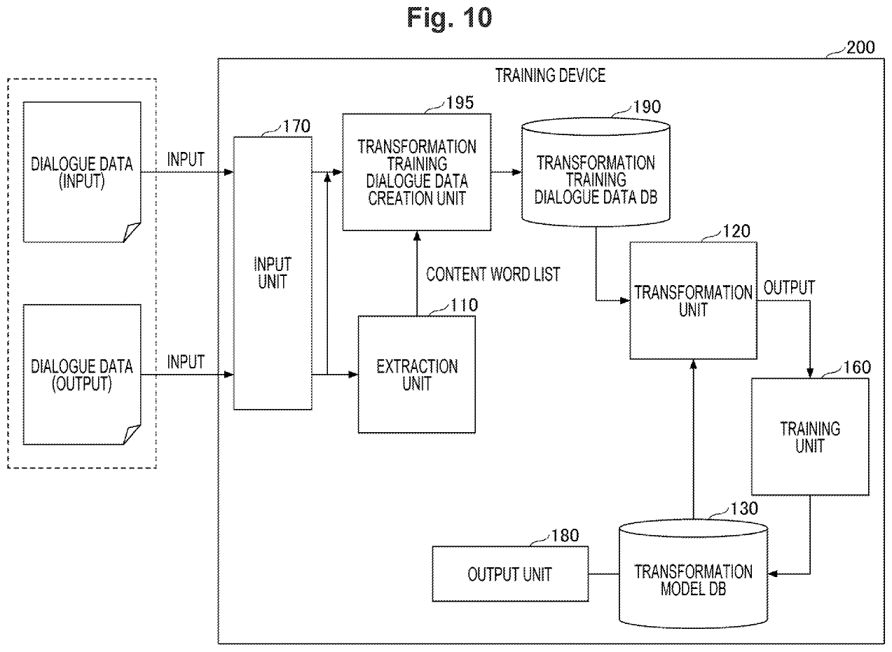

Next, a device configuration and a device operation in the training phase will be described. FIG. 10 is a configuration diagram of the training device 200 that performs training of the transformation model in the training phase. As illustrated in FIG. 10, the training device 200 includes the extraction unit 110, the transformation unit 120, the transformation model DB 130, the training unit 160, an input unit 170, an output unit 180, a transformation training dialogue data DB 190, and a transformation training dialogue data creation unit 195. Note that each of the transformation model DB 130 and the transformation training dialogue data DB 190 may be DBS external to the training device 200.

The functions of the extraction unit 110, the transformation unit 120, and the transformation model DB 130 are the same as the functions described regarding the inference phase. However, in the training phase, the transformation model (parameter) in the middle of training is stored in the transformation model DB 130 until the training is completed. The transformation unit 120 holds the transformation model (parameter) read from the transformation model DB 130.

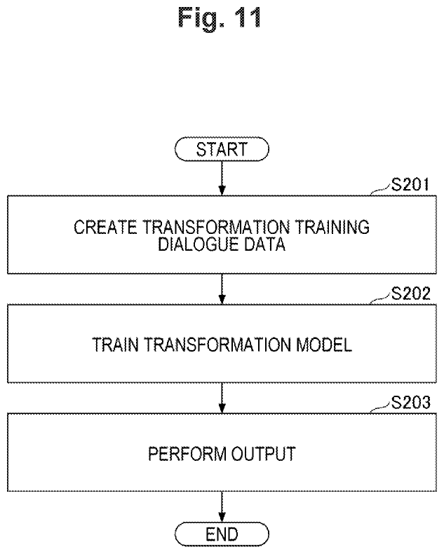

A schematic operation of the training device 200 will be described with reference to a flowchart of FIG. 11. Here, it is assumed that a pre-trained dialogue model using the general dialogue data is stored in the transformation model DB 130 as a training target transformation model.

In S201, the extraction unit 110 and the transformation training dialogue data creation unit 195 create the transformation training dialogue data from the dialogue data input from the input unit 170. The created transformation training dialogue data is stored in the transformation training dialogue data DB 190.

Note that generating the transformation training dialogue data using the extraction unit 110 and the transformation training dialogue data creation unit 195 is an example. The transformation training dialogue data may be manually created, and the created transformation training dialogue data may be stored in the transformation training dialogue data DB 190.

As described below, the dialogue data serving as the input has an input portion and an output portion. The output portion of the dialogue data is input to the extraction unit 110 to generate the content word list. The transformation training dialogue data creation unit 195 creates an input portion of the transformation training dialogue data by combining the input portion of the dialogue data and the content word list, and creates the transformation training dialogue data by using the input portion and the output portion of the dialogue data as a pair.

In S202, the input portion of the transformation training dialogue data is input to the transformation unit 120, and the transformation unit 120 obtains an output from the transformation model by inputting the input portion to the transformation model. The training unit 160 updates the parameter of the transformation model so that the difference between the output from the transformation model and the output portion (correct answer) of the transformation training dialogue data is minimized.

When the training in S202 is completed, for example, the trained transformation model is output from the output unit 180 in S203. This transformation model is used, for example, as a transformation model in the generation device 100.

The above-described transformation model is a model obtained by fine-tuning the above-described dialogue model (example: Transformer Encoder-decoder dialogue model published by the applicant). That is, the dialogue model trained with the general dialogue data cannot be used for the purpose of the generation device 100, and it is necessary to transform the input and the output into a format suitable for a training framework. Fine-tuning is performed on the original dialogue model by using the transformation training dialogue data, so that the transformation model trained with a desired input/output is created.

Hereinafter, main components appearing in the above-described processing in the training phase will be described in detail.

### <General Dialogue Data>

The general dialogue data is data used to perform pre-training of the transformation model. In general, a dialogue system is constructed by learning a rough dialogue flow by pre-training using large-scale dialogue data and performing fine-tuning with a small amount of dialogue data related to a specific topic. As described above, since the pre-trained dialogue model is available online, the general dialogue data is unnecessary with the use of the dialogue model. If pre-training is independently performed using general dialogue data, it is possible to construct a dialogue model by crawling large-scale dialogue data such as SNSs and using a training framework such as Fairseq. In the following description, it is assumed that a pre-trained dialogue model is used as a dialogue model that is a source of the transformation model.

### <Transformation Training Dialogue Data>

The transformation training dialogue data is data created from the dialogue data, and is training data for training a transformation model for generating an utterance that is suitable for the dialogue context and conforms to the content of the content word list from the dialogue context and the content word list. Any dialogue data (sequence of utterances) can be used as the dialogue data that is a source of the transformation training dialogue data, and in the following description, data of a discussion dialogue will be described as an example of the dialogue data.

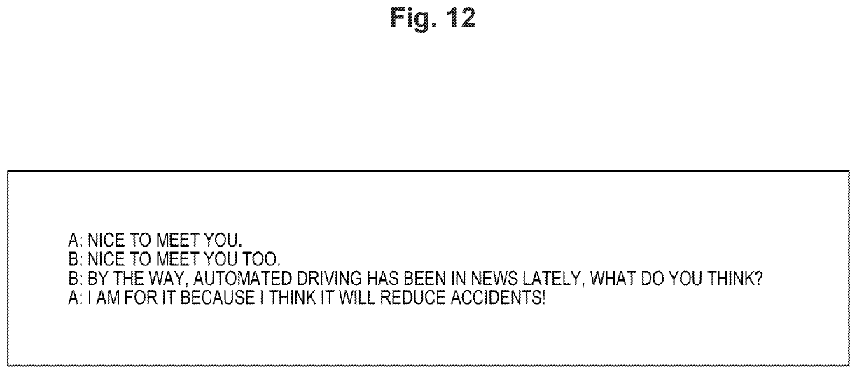

FIG. 12 illustrates an example of dialogue data used for creating transformation training dialogue data. The settings of speaker A and speaker B are similar to those in FIG. 3 (dialogue context). Here, on the basis of the present dialogue data, the transformation training dialogue data is created using the extraction unit 110.

At this time, the dialogue data is divided into an input and an output for training, and the data up to a specific utterance is used as an input and the specific utterance is used as an output. In the case of the example illustrated in FIG. 12, for example, the first to third utterances are inputs, and the fourth utterance is an output. This is an example, and the input and the output can be arbitrarily set. The processing of dividing the dialogue data into the input and the output may be performed manually, or may be automatically performed by the training device 200 (for example, the transformation training dialogue data creation unit 195). Note that the input portion (not including the content word list) in the dialogue data may be referred to as a dialogue context.

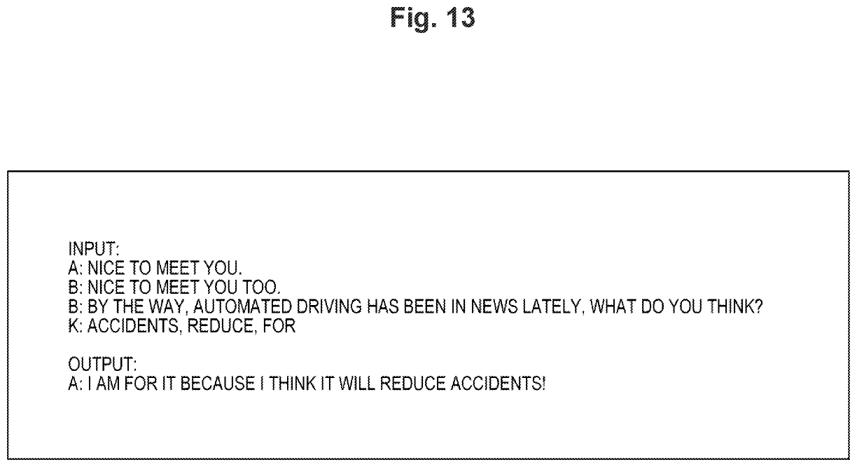

FIG. 13 illustrates an example of the transformation training dialogue data created by applying the extraction unit 110 to the dialogue data of FIG. 12. In the example of FIG. 13, the fourth utterance in the dialogue data is set as an output of the training target, and up to the third utterance is set as an input of the training target. More specifically, the content word list is obtained by inputting the output (fourth utterance) to the extraction unit 110. The transformation training dialogue data creation unit 195 adds a list (a line starting with K in the example) obtained by connecting the content words in the content word list with commas to the end of the input.

The transformation training dialogue data creation unit 195 stores the input to which the list is added and the output (fourth utterance) as a pair in the transformation training dialogue data DB 190.

The input portion of the pair is input to the transformation unit 120. The training unit 160 updates the parameter so that the difference between the output from the transformation unit 120 and the output portion of the pair is minimized.

By training the transformation model by using the pair of input and output having the above format, the transformation model is trained that generates an output on the basis of the dialogue context up to the third utterance and the content of the content word list described in the fourth line.

At this time, in the training of the transformation model, if the information of the dialogue context is not included in the input, the utterance to be output cannot consider the dialogue context. In addition, if the content word list is not included in the input, the utterance to be output does not have the content along the scenario (adjusted to the scenario) and does not become the utterance having the expected content. As illustrated in FIG. 13, these problems are solved by using, for training, the input including the information of the dialogue context and the content word list corresponding to the output.

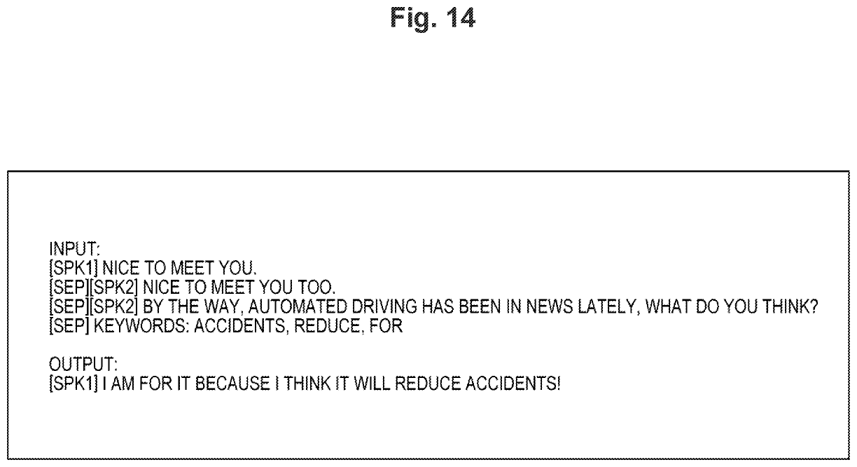

FIG. 14 illustrates an example of an input/output pair actually used for training. The input/output pair may be stored in the transformation training dialogue data DB 190 in the format illustrated in FIG. 14, or the format illustrated in FIG. 14 may be used when the training data is input from the transformation training dialogue data DB 190 to the transformation unit 120.

The data illustrated in FIG. 14 is an example of data obtained by transforming the input/output pair illustrated in FIG. 13. In the example illustrated in FIG. 14, the input spans a plurality of lines, but in practice, there is no line feed and the input is input to the transformation unit 120 as a text of one line. SPK1 represents speaker A, SPK2 represents speaker B, and SEPs represent input delimiters (for example, those arranged between utterances).

Note that, in the above example, the data used for training is a sentence, but the data used for training is not limited to the sentence. For example, the “output portion of the dialogue data” described above may be a specific image in a video (or a specific video). In this case, the specific image (or specific video) is input to the extraction unit 110, the extraction unit 110 outputs content information (example: a content word) indicating the content of the specific image (or the specific video), and the content information is input to the transformation unit 120 together with the dialogue context (input portion of the dialogue data). Then, for example, the transformation model is trained by comparing the output (utterance) from the transformation unit 120 with a natural sentence describing the specific image (or the specific video).

### Hardware Configuration Example

Any device (generation device 100, training device 200) described in the present embodiment can be implemented by causing a computer to execute a program, for example. This computer may be a physical computer, or may be a virtual machine on a cloud.

Specifically, the device can be implemented by executing a program corresponding to the processing to be performed in the device, using hardware resources such as a CPU and a memory built into the computer. The above-described program can be stored and distributed by being recorded on a computer-readable recording medium (portable memory, and the like). In addition, the above-described program can also be provided through a network such as the Internet or an electronic mail.

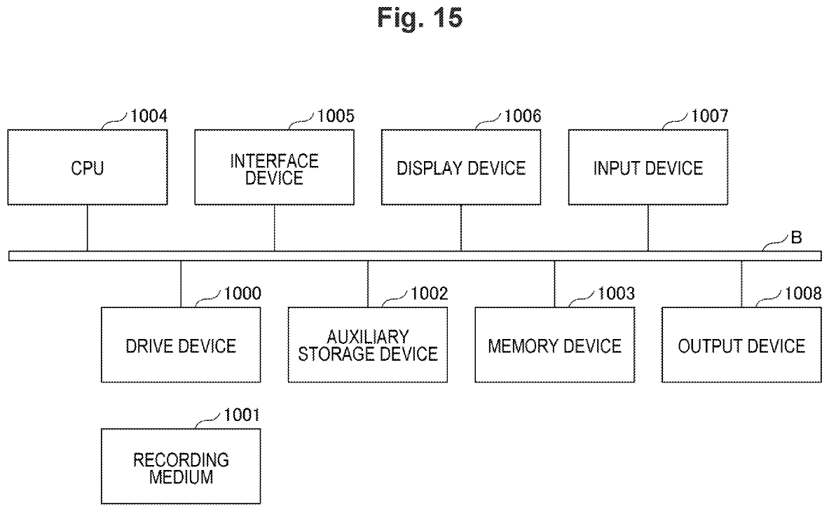

FIG. 15 is a diagram illustrating a hardware configuration example of the computer. The computer in FIG. 15 includes a drive device 1000, an auxiliary storage device 1002, a memory device 1003, a CPU 1004, an interface device 1005, a display device 1006, an input device 1007, and an output device 1008, which are connected to one another by a bus BS. Note that the computer may further include a GPU.

The program for implementing processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 implements a function related to the device in accordance with a program stored in the memory device 1003. The interface device 1005 is used as an interface for connecting to a network or the like. The display device 1006 displays a Graphical User Interface (GUI) or the like according to the program. The input device 1007 is configured with a keyboard and a mouse, a button, a touch panel, or the like, and is used to input various operation instructions. The output device 1008 outputs a calculation result.

### Summary of Embodiments, Effects, or the Like

As described above, when a natural sentence or a sequence thereof is prepared as a scenario by the technique described in the present embodiment, an utterance that is consistent with the prepared scenario and has fluency for the dialogue context can be generated for an arbitrary dialogue context.

For example, when there is data (generally called a knowledge base) in which knowledge about a specific topic is collected in a natural sentence form and dialogue data about a specific topic, it is possible to fluently utter the knowledge with respect to an arbitrary dialogue context. This makes it possible to respond fluently to the user's utterance while being consistent with the knowledge, and to generate a consistent and fluent dialogue on the basis of the knowledge base (a method generally called self-dialogue in which one system is divided into speaker A and speaker B and alternately utters to generate a dialogue).

Note that the above-described knowledge base corresponds to the scenario, and the dialogue data corresponds to data that is a source of the transformation training dialogue data.

Regarding the above embodiment, the following supplementary notes are further disclosed.

### Supplementary Notes

### (Supplement 1)

A generation device including:
a memory; and
at least one processor connected to the memory,
in which
the processor
extracts one or more pieces of content information indicating content of specific information from the specific information, and
generates an utterance adjusted to the content of the specific information and matching a dialogue context from the dialogue context and the one or more pieces of content information by using a transformation model.

### (Supplement 2)

The generation device according to supplement 1, in which the dialogue context is one or more utterances generated by the transformation unit.

### (Supplement 3)

A training device including:
a memory; and
at least one processor connected to the memory,
in which
the processor
generates an utterance from a dialogue context and one or more pieces of content information indicating content of specific information by using a transformation model, and
trains the transformation model so that the utterance becomes an utterance adjusted to the content of the specific information and matching the dialogue context.

### (Supplement 4)

The training device according to supplement 3, in which the processor extracts the one or more pieces of content information indicating the content of the specific information from the specific information.

### (Supplement 5)

A generation method executed by a computer, the generation method including:
an extraction step of extracting one or more pieces of content information indicating content of specific information from the specific information; and
a transformation step of generating an utterance adjusted to the content of the specific information and matching a dialogue context from the dialogue context and the one or more pieces of content information by using a transformation model.

### (Supplement 6)

A training method executed by a computer, the training method including:
a transformation step of generating an utterance from a dialogue context and one or more pieces of content information indicating content of specific information by using a transformation model; and
a training step of training the transformation model so that the utterance becomes an utterance adjusted to the content of the specific information and matching the dialogue context.

### (Supplement 7)

A non-transitory storage medium that stores a program for causing a computer to function as each unit in the generation device according to supplement 1 or 2.

### (Supplement 8)

A non-transitory storage medium that stores a program for causing a computer to function as each unit in the training device according to supplement 3 or 4.

Although the present embodiment has been described above, the present invention is not limited to such a specific embodiment, and various modifications and changes can be made within the scope of the gist of the present invention described in the claims.

### REFERENCE SIGNS LIST

100 Generation device
110 Extraction unit
120 Transformation unit
130 Transformation model DB
140 Input unit
150 Output unit
200 Training device
160 Training unit
170 Input unit
180 Output unit
190 Transformation training dialogue data DB
195 Transformation training dialogue data creation unit
1000 Drive device
1001 Recording medium
1002 Auxiliary storage device
1003 Memory device
1004 CPU
1005 Interface device
1006 Display device
1007 Input device
1008 Output device

1. A generation device comprising:
extracting one or more pieces of content information indicating content of specific information from the specific information; and
generating an utterance adjusted to the content of the specific information and matching a dialogue context from the dialogue context and the one or more pieces of content information by using a transformation model.

2. The generation device according to claim 1, wherein the dialogue context is one or more utterances generated.

3. A training device comprising:
generating an utterance from a dialogue context and one or more pieces of content information indicating content of specific information by using a transformation model; and
training the transformation model so that the utterance becomes an utterance adjusted to the content of the specific information and matching the dialogue context.

4. The training device according to claim 3, further comprising:
extracting the one or more pieces of content information indicating the content of the specific information from the specific information.

5. A generation method executed by a computer, the generation method comprising:
extracting one or more pieces of content information indicating content of specific information from the specific information; and
generating an utterance adjusted to the content of the specific information and matching a dialogue context from the dialogue context and the one or more pieces of content information by using a transformation model.

6. A training method executed by a computer, the training method comprising:
a generating an utterance from a dialogue context and one or more pieces of content information indicating content of specific information by using a transformation model; and
training the transformation model so that the utterance becomes an utterance adjusted to the content of the specific information and matching the dialogue context.

7. A program for causing a computer to function as each unit in the generation device according to claim 1.

8. A program for causing a computer to function as each unit in the training device according to claim 3.

9. A program for causing a computer to function as each unit in the generation device according to claim 2.

10. A program for causing a computer to function as each unit in the training device according to claim 4.

11. The generation device according to claim 1, wherein an utterance inference phase and dialogue are generated.

12. The generation device according to claim 1, wherein a plurality of content words is extracted from a scenario and outputs a word list.

13. The generation device according to claim 1, wherein a conversion model is trained to read out and hold the conversion model.

14. The generation device according to claim 1, wherein the utterance is an output that matches the dialogue context.

15. The generation method according to claim 5, wherein an empty string is used as a first input to generate a first utterance and the first utterance is used as an input to generate a second utterance.

16. The generation method according to claim 5, wherein a template utterance is included to generate the utterance.

17. The generation device according to claim 12, wherein a morpheme string and part of speech are received from the content word and determines which of the morpheme string is excluded.

18. The generation method according to claim 5, wherein a conversion learning dialogue is generated from dialogue data input.

19. The training method according to claim 6, wherein a general dialogue data is used for pre-training of a conversion model.

20. The training method according to claim 19, wherein a dialogue system is constructed by learning a general flow of dialogue through the pre-trained conversion model.
